(19) United States
(12) Patent Application Publication
(10) Pub. No.: US 2025/0278636 A1
(43) Pub. Date: Sep. 4, 2025

(54) END-TO-END TRAINED GENERATIVE SLATE RECOMMENDATION MODEL

(71) Applicant: Pinterest, Inc., San Francisco, CA (US)

(72) Inventors: Prabhat Agarwal, Mountain View, CA (US); Nikil Pancha, San Francisco, CA (US); Jiajing Xu, Palo Alto, CA (US); Andrew Huan Zhai, Belmont, CA (US)

(73) Assignee: Pinterest, Inc., San Francisco, CA (US)

(21) Appl. No.: 18/592,099

(22) Filed: Feb. 29, 2024

(51) Int. Cl. G06N 3/092; G06N 3/0475

(52) U.S. Cl. CPC G06N 3/092; G06N 3/0475

(57) ABSTRACT

Described is an end-to-end generative recommendation model configured to determine a slate of content items to present to a user and the training thereof. The slate recommendation model may employ a generative model (e.g., generative transformer-based model, etc.) that is trained employing a multi-stage training approach. First, a generative model may be trained to learn a sequence model configured to generate a sequence of content items. The trained model may then be fine-tuned to better learn a distribution of slate recommendations. After fine-tuning of the model, a reward model may be trained based on one or more objectives. The reward model may be employed using a reinforcement learning technique or direct preference optimization technique to further fine-tune the model to bias the slate recommendations in view of the one or more objectives.

### BACKGROUND

The amount of accessible content is ever expanding. For example, there are many online services that host and maintain content for their users and subscribers. Further, in connection with the hosting and maintenance of the accessible content, many online services may provide search, recommendation, personalization, and/or other services to facilitate access to the content. Oftentimes, such online services will employ multi-stage recommendation systems and/or services which may include multiple trained machine learning models configured to determine a feed of content items to present to users of the online service from a corpus of content. Such recommendation systems typically employ learn to rank techniques that generally generate a feed of content items based on scores determined for each individual content item. These techniques are typically greedy and usually ignore the influence of other content items included in the feed. Further, the various stages of such multi-state recommendation systems are typically trained separately. These factors, and others, may negatively impact the quality of the recommended content items in a user's feed of content items.

### BRIEF DESCRIPTION OF THE DRAWINGS

The detailed description is described with reference to the accompanying figures.

FIG. 1 is an illustration of an exemplary computing environment, according to exemplary embodiments of the present disclosure.

FIG. 2 is a block diagram illustrating an exemplary recommendation service, according to exemplary embodiments of the present disclosure.

FIGS. 3A and 3B are illustrations of an exemplary sequence model and an exemplary reward model, according to exemplary embodiments of the present disclosure.

FIG. 4 is a flow diagram of an exemplary content recommendation process, according to exemplary embodiments of the present disclosure.

FIG. 5 is a flow diagram illustrating an exemplary machine learning model training process, according to exemplary embodiments of the present disclosure.

FIG. 6 is a flow diagram of an exemplary fine-tuning process, according to exemplary embodiments of the present disclosure.

FIG. 7 is a flow diagram of an exemplary machine learning model training process, according to exemplary embodiments of the present disclosure.

FIG. 8 is a block diagram of an exemplary computing resource, according to exemplary embodiments of the present disclosure.

### DETAILED DESCRIPTION

As is set forth in greater detail below, embodiments of the present disclosure are generally directed to an exemplary end-to-end generative recommendation model configured to determine a slate of content items to present to a user. According to exemplary embodiments of the present disclosure, the exemplary recommendation model may employ a generative model (e.g., generative transformer-based model, etc.) that is trained employing a multi-stage training approach. For example, a generative model may be trained to learn a sequence model configured to generate a sequence of content items based on a user's history, contextual information, and the like. The trained model may then be fine-tuned to better learn a distribution of recommended slates of content items for improved quality in the recommended slates that are presented to the user. After fine-tuning of the model, a reward model may be trained based on one or more objectives. The reward model may be employed using a reinforcement learning technique to further fine-tune the model to bias the slate recommendations in view of the one or more objectives. The trained model may then be deployed as part of a recommendation system to serve slate recommendations to users that are based at least in part on the one or more objectives.

According to exemplary embodiments of the present disclosure, the exemplary recommendation model may be deployed by an online service for serving slate recommendations to users of the online service. For example, a sequence of user actions, along with contextual information, may be provided as inputs to the exemplary generative recommendation model. The exemplary generative recommendation model may process the sequence of user actions and the contextual information to generate a recommended slate of content items. The sequence of user actions may correspond to a sequence of content items with which the user has interacted, and the contextual information may include information associated with the request for content items (e.g., a type of request for content items—a response to a query, a request to populate a homepage, a shopping session, a request for recommended content, in connection with a push notification providing content, etc.—a time of the request for content, and the like). According to certain aspects of the present disclosure, the content items may be encoded as embeddings, ID representations specified in a mapping to corresponding content items, and the like, and may include dynamic content items that dynamically change as users interact with them (e.g., changes in metadata, annotations, associated content graph edges, associated content graph weights, associated content graph clusterings, associated content graph taxonomical relationships, changes in other attributes, etc.). The exemplary recommendation model may process the representations (e.g., embeddings, ID representation, etc.) of the sequence of content items corresponding to the user actions and the contextual information to generate a sequence of representations (e.g., an embedding, ID representation, etc.) corresponding to recommended content items to be included in a slate of content items to be presented to the user. Further, the exemplary recommendation model may have been trained to bias the recommendation model to determine slate recommendations in view of one or more objectives. Accordingly, the sequence of representations that correspond to the content items being recommended for the slate may further be determined based on the one or more objectives used to train the model.

Exemplary embodiments of the present disclosure may also provide methods and processes for training the exemplary recommendation model. In an exemplary implementation, a supervised learning technique may be employed to train an initial sequence model using training data that includes both user interaction information and contextual information. The initial sequence model may be configured to determine a sequence of content items with which it is expected the user will interact and/or engage. Alternatively and/or in addition, one or more pre-trained sequence models that are configured to generate a sequence of content items may be obtained. The sequence model (e.g., trained and/or pre-trained, etc.) may then be fine-tuned using training data that includes user history, contextual information, and slate information, so that the model may further learn relationships and patterns between the sequence of content items in the recommended slates of content items in determining slates of content items. Alternatively and/or in addition, one or more pre-trained models configured to generate slate recommendations may be obtained. Subsequently, a reward model may be trained to generate a reward signal in connection with slate recommendations that are based on one or more objectives, and the reward signal from the trained reward model may be employed using a reinforcement learning human feedback (RLHF) technique to fine-tune the model to maximize the reward, thereby biasing the model to slate recommendations based on the one or more objectives. Alternatively, a rule-based heuristic reward model may be employed. Additionally, rather than employing a RLHF technique, the model may be optimized (e.g., using a direct preference optimization technique, etc.) based on the reward model. Further, in exemplary implementations where it may be desirable to modify the one or more objectives, a new model may be trained in view of new and/or updated objectives, which may then be used to fine-tune the recommendation model in view of the new and/or updated objectives without having to retrain the entire model.

Advantageously, the exemplary embodiments of the present disclosure can provide an end-to-end generative recommendation model configured to generate a slate of recommended content items that does not rely on heuristics, along with the cost of managing and tuning such heuristics. Further, the exemplary recommendation model is adaptable, such that it may be configured to provide slate recommendations across different presentations of content (e.g., in response to a query, in response to a request to access a homepage, etc.), as well as receive inputs of sequences of user actions across multiple content item types and generate slate recommendations including content items having multiple content item types. Further, the end-to-end configuration of the exemplary recommendation model also enables the entire model to be accessed during each training stage, rather than being confined to individual portions of the model. Additionally, the slate recommendation model produced according to exemplary embodiments of the present disclosure may be easily tuned in view of new and/or additional objectives.

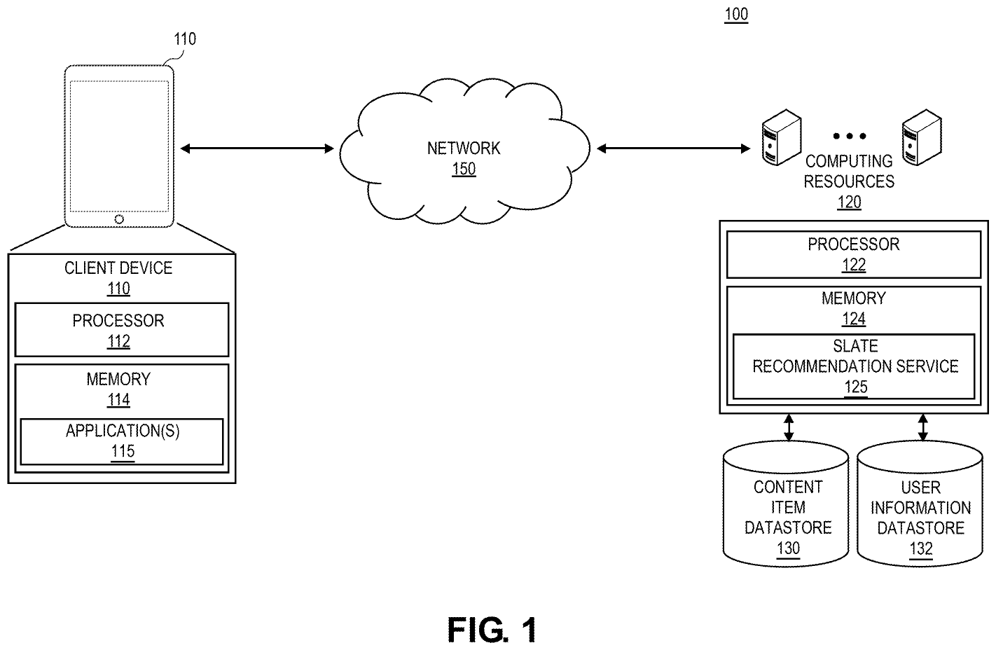

FIG. 1 is an illustration of an exemplary computing environment 100, according to exemplary embodiments of the present disclosure.

As shown in FIG. 1, computing environment 100 may include one or more client devices 110, also referred to as user devices, for connecting over network 150 to access computing resources 120. Client device 110 may include any type of computing device, such as a smartphone, tablet, laptop computer, desktop computer, wearable, etc., and network 150 may include any wired or wireless network (e.g., the Internet, cellular, satellite, Bluetooth, Wi-Fi, etc.) that can facilitate communications between client device 110 and computing resources 120. Computing resources 120 may include one or more processor(s) 122 and one or more memory 124, which may store one or more applications, such as slate recommendation service 125, that may be executed by processor(s) 122 to cause processor(s) 122 of computing resources 120 to perform various functions and/or actions. According to aspects of the present disclosure, computing resources 120 may represent at least a portion of a networked computing system that may be configured to provide online applications, services, computing platforms, servers, and the like, such as a social networking service, social media platform, e-commerce platform, content recommendation services, search services, and the like, that may be configured to execute on a networked computing system. Further, computing resources 120 may communicate with one or more datastore(s), such as content item datastore 130, which may be configured to store and maintain a corpus of digital content items from which content recommendation service 125 may determine and/or identify content items that may be included in the slates being recommended and provided to client device 110, user information datastore 132, which may be configured to store and maintain user profile information, user actions, user interactions, user preferences, and/or user histories associated with users of an online service provided by computing resources 120 that may be processed by slate recommendation service 125 in determining the slate recommendations to serve to client device 110. The content items stored and maintained by content item datastore 130 may include any type of digital content, such as digital images, videos, documents, advertisements, and the like.

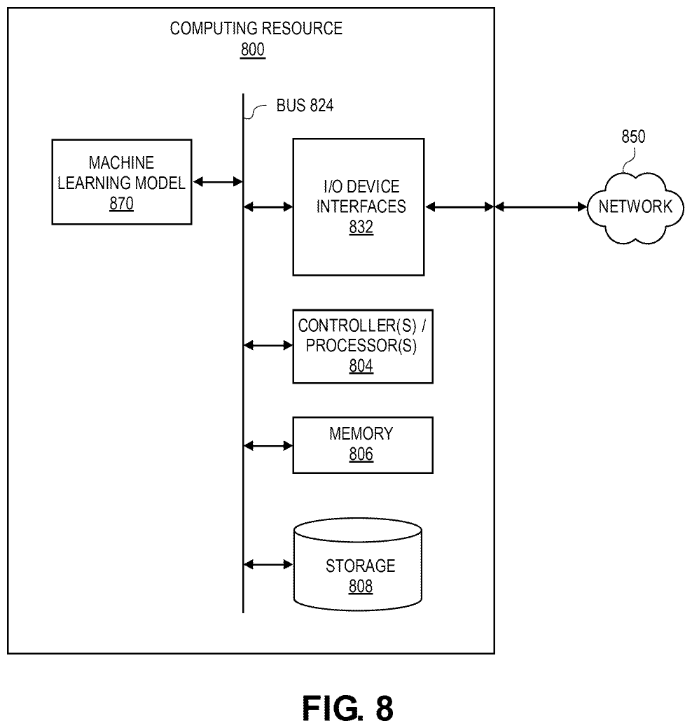

According to exemplary implementations of the present disclosure, computing resources 120 may be representative of computing resources that may form a portion of a larger networked computing platform (e.g., a cloud computing platform, and the like), which may be accessed by client device 110. Computing resources 120 may provide various services and/or resources and do not require end-user knowledge of the physical premises and configuration of the system that delivers the services. For example, computing resources 120 may include “on-demand computing platforms,” “software as a service (SaaS),” “infrastructure as a service (IaaS),” “platform as a service (PaaS),” “platform computing,” “network-accessible platforms,” “data centers,” “virtual computing platforms,” and so forth. As shown in FIG. 1, computing resources 120 may be configured to execute and/or provide a social media platform, a social networking service, a recommendation service, a search service, an e-commerce platform, or any other form of interactive computing. Example components of a remote computing resource, which may be used to implement computing resources 120, are discussed below with respect to FIG. 8.

As illustrated in FIG. 1 client device 110 may access and/or interact with slate recommendation service 125 through network 150 via one or more applications 115 operating and/or executing on client device 110. For example, users associated with client device 110 may launch and/or execute such an application on client device 110 to access and/or interact with applications and/or services executing on computing resources 120 via network 150. According to aspects of the present disclosure, a user may, via execution of applications 115 on client device 110, access or log into services executing on computing resources 120 by submitting one or more credentials (e.g., username/password, biometrics, secure token, etc.) through a user interface presented on client device 110.

Once logged into services executing on remote computing resources 120, users associated with client device 110 may navigate, view, access, and/or otherwise consume content items on client device 110 as part of a social media platform or environment, a networking platform or environment, an e-commerce platform or environment, or through any other form of interactive computing. In connection with the user's activity on client device 110 with the online services provided by computing resources 120, which may include the consumption of content, a request for a slate of content may be received from client device 110 by computing resources 120. For example, a slate of content may include any presentation of more than one content item, and the request for a slate of content may be included in a query (e.g., a text-based query, an image query, etc.), a request to access a homepage and/or home feed, a request for recommended content items, browsing and/or consuming content via the service, and the like. Alternatively and/or in addition, services executing on remote computing resources 120 may push a slate of content to client device 110. For example, services executing on remote computing resources 120 may push recommended content items to client device 110 on a periodic basis, after a certain period of time has elapsed, based on certain activity associated with client device 110, upon identification of relevant and/or recommended content items that may be provided to client device 110, and the like.

In response to a request for a slate of content, slate recommendation service 125 may obtain various information and parameters associated with the user and the request for a slate of content (e.g., user actions/interactions, user history information, user profile information, user preferences, contextual information, embeddings and/or vectors representative of the user, etc.) to determine and/or identify a recommended slate of content from a corpus of content items (e.g., stored and/or maintained by content item datastore 130). For example, the various information and parameters, such as user history information, user actions, and the like, may be obtained from user information datastore 132, and contextual information may be obtained from client device 110 in connection with the request for a slate of content.

The obtained information and parameters may be processed by slate recommendation service 125 to determine and/or identify a slate of recommended content items to be presented to the user on client device 110. According to exemplary embodiments of the present disclosure, content recommendation service 125 may include a generative recommendation model that may include one or more machine learning models, such as a transformer-based deep neural networks (“DNN”), etc., that is trained to determine and/or identify content from a corpus of content items (e.g., stored and/or maintained by candidate content item datastore 130) to include in a recommended slate and provide to client device 110.

In exemplary implementations, the generative recommendation model employed by slate recommendation service 125 may be configured to receive one or more inputs, which may include a sequence of user actions, contextual information, and the like, and determine a slate recommendation that may be presented on client device 110 to the user. For example, the sequence of user actions may correspond to a sequence of content items with which the user has interacted (e.g., clicked, saved, shared, posted, liked, purchased, etc.), and the contextual information may include information associated with the request for a slate of content items (e.g., a type of request for the slate of content items—a type of request for content items—a response to a query, a request to populate a homepage, a shopping session, a request for recommended content, in connection with a push notification providing content, etc.—a time of the request, device information, device type, device display type, device display orientation, and the like). According to certain aspects of the present disclosure, the sequence of content items may be encoded as a sequence of embeddings encoding features of the sequence of content items, learned ID representations specified in a mapping to corresponding content items (e.g., semantic ID, etc.), other learned representations, and the like. Further, the content items may include collections of content items, content items of multiple different types, such as images, advertisements, shopping objects, dynamic content items that dynamically change as users interact with them (e.g., changes in metadata, annotations, associated content graph edges, associated content graph weights, associated content graph clusterings, associated content graph taxonomical relationships, changes in other attributes, etc.), and the like. According to exemplary embodiments of the present disclosure, the content items may be represented as embeddings associated with nodes of a corpus graph, as described in U.S. patent application Ser. No. 16/273,860, filed on Feb. 12, 2019, which is hereby incorporated by reference herein in its entirety. Accordingly, the content items may not be simple static content items such as images that may include a static representation, but instead may include content items that include various metadata, annotations, and/or other associated attributes, such as content graph relationships (e.g., edges, clusterings, weightings, taxonomical relationships, etc.), and the like, that may dynamically change as users interact with the content items (e.g., via likes, shares, saves, clicks, linking, the adding of annotations, etc.). Accordingly, as the metadata, annotations, content graph relationships, and/or other associated attributes associated with such content items change, the embeddings, learned ID representations, and the like encoding features of such content items will also dynamically change to reflect the changes of the content items.

According to exemplary embodiments of the present disclosure, the exemplary recommendation model may process the sequence of representations (e.g., embeddings, learned ID representation, etc.) corresponding to the sequence of user actions and the contextual information to generate a sequence of representations (e.g., an embedding, learned ID representation, etc.) corresponding to recommended content items to be included in a slate of content items to be presented to the user. According to aspects of the present disclosure, the sequence of content items may include content items of multiple different types, such as collections of content items, images, advertisements, shopping objects, dynamic content items that dynamically change as users interact with them, and the like. In certain exemplary implementations, the generated representations may include encodings of particular and/or specific content items included in a corpus of content items (e.g., stored and maintained in content item datastore 130). Alternatively and/or in addition, the generated representations may be used to identify corresponding content items based on similarity measure between the generated representations and the representations of content items of the corpus of content items (e.g., Euclidean similarity, cosine similarity, clustering techniques, nearest neighbor techniques, random walks, etc.). Accordingly, the content items corresponding to the sequence of generated representations may be included in the recommended slate and provided to client device 110.

Exemplary embodiments of the present disclosure may also provide methods and processes for training the exemplary recommendation model. In exemplary implementations of the present disclosure, the corpus of content items may be represented as D, and a slate s of size K may be defined as an ordered list of content items where s=(d₁, d₂, . . . , d_{K}), where dₖ∈D and positional index k∈{1, . . . , K} represents that the item appeared in the k-th slot in the slate. A user's response to a slate s is denoted as r=(r₁, r₂, . . . , r_{K}), where rₖ may represent the user's response to item dₖ, where rₖ∈{0, 1} and represents whether the user engaged with content item dₖ. Additionally, z may represent a user's history (e.g., that may be represented as a sequence of user interactions) and c may represent contextual information (e.g., the type of the request for a slate—a query, request to access a homepage, etc.—a timestamp, and the like). Unlike traditional discriminative ranking methods that model R (r|s, z, c), which represents the user response for a given slate, the exemplary generative recommendation model according to exemplary embodiments of the present disclosure is configured to learn the distribution of slates, which may be represented as P_θ(s|z, c).

Further, exemplary embodiments of the present disclosure may approach slate recommendations as a sequence generation problem. Accordingly, the user history z may include a sequence of content items with which the user has interacted and/or engaged (e.g., clicked, saved, shared, posted, liked, purchased, etc.) and may be expressed as z=i_1, i_2, . . . , i_n, where i_k represents a content item in the sequence of past content items with which the user has engaged and/or interacted. Further, the context may be represented as a sequence of tokens drawn from a fixed vocabulary. According to an aspect of the present disclosure, in implementations where the request for a slate of content items is received in connection with a search and/or query, the contextual information may include the search query as a tokenized query. Accordingly, the slate recommendation problem may be represented as learning the probability of:

$$P ( s \vert i\_ 1 , i\_ 2 , … , i\_n , c\_ 1 , c\_ 2 , … , c\_m )$$

Additionally, certain aspects of the present disclosure may also apply a causal relationship between content items included in the slate. For example, it may be assumed that users typically engage a slate of content items from the beginning of the slate to the end of the slate. Accordingly, it may be assumed that content items may be influenced by preceding content items in the slate, but not by content items subsequently appearing in the slate. Alternatively and/or in addition, the content items may be considered as groupings of content items rather than individual content items in the slate. Based on the above assumptions, the slate recommendation problem may be explained as learning the likelihood of an item at slot i of the slate s based on user history z, context c, and prior slate items s_x<i, which may be represented as learning the probability of:

$$P ( s\_i \vert i\_ 1 , i\_ 2 , … , i\_n , c\_ 1 , c\_ 2 , … , c\_m , s\_ 1 , s\_ 2 , … , s\_i - 1 )$$

Further, exemplary embodiments of the present disclosure may employ a reinforcement learning technique with a reward model to maximize a cumulative reward for the slate based on one or more objectives. According to an exemplary implementation, the fine-tuning of the model based on the objective may be represented as:

$$objective = arg {max}_{π} {𝔼}_{context ∼ D , s \_ i \sim P ( s \_ i \vert i \_ 1 , … )} [ {r}_{θ} ( context , s\_i ) ) ]$$

In view of the above-described probabilities and distributions to be learned via training of the recommendation model, exemplary implementations of the present disclosure may utilize a multi-stage training approach in training the generative recommendation model. For example, an initial sequence model may first be trained to learn a conditional probability indicative of the probability of each subsequent user interaction given the preceding user actions in a sequence. Alternatively and/or in addition, a pretrained sequence recommendation system employing one or more pretrained models may be obtained and utilized in place of training an initial sequence model. The trained sequence model (e.g., trained and/or pre-trained) may then be fine-tuned using training data incorporating user history, contextual information, and content item slate information, so that the model may further learn relationships and pattern between the sequence of content items in the recommended slates of content items. Alternatively and/or in addition, a slate recommendation system employing one or more pre-trained models configured to generate slate recommendations may be obtained in place of fine-tuning an initial sequence model. Subsequently, a reward model may be trained to generate a reward signal based on one or more objectives, and the reward signal from the trained reward model may be employed using a reinforcement learning technique (e.g., reinforcement learning using human feedback (RLHF), etc.) to further fine-tune the model to maximize the reward, thereby biasing the model to slate recommendations based on the one or more objectives. Alternatively, a rule-based heuristic reward model may be employed. Additionally, rather than employing a RLHF technique to fine-tune the model, an optimization technique (e.g., using a direct preference optimization technique, etc.) may be employed to optimize the model based on the reward model. Further, in exemplary implementations where it may be desirable to modify the one or more objectives, a new model may be trained in view of new and/or updated objectives, which may then be used to fine-tune the recommendation model in view of the new and/or updated objectives without having to retrain the entire model.

According to exemplary embodiments of the present disclosure, during a first training stage, a supervised learning technique may be employed to train an initial sequence model using training data incorporating user interaction information and contextual information. For example, user history and contextual information may be collated as sequences in the generation of training data. Accordingly, given a sequence of user interactions and a sequence of contextual information, a model (e.g., a decoder-only transformer model, etc.) may be trained to learn a conditional probability indicative of the probability of each subsequent user interaction given the preceding user actions in the sequence.

Exemplary embodiments of the present disclosure may employ either a discrete or a continuous representation approach in training the generative recommendation model. In a discrete representation approach, the sequence of user interactions and the contextual information may be represented utilizing hierarchical semantic identifiers, while the contextual information is represented by a set of tokens. The discrete representation approach can facilitate encapsulating the information concisely and in a structured manner, which can facilitate improved interpretability of patterns in the information. Further, a cross-entropy loss may be employed in training the recommendation model in employing the discrete representation approach.

In a continuous representation approach, pretrained embeddings may represent both the sequence of user interactions and the contextual information. The continuous representation approach can facilitate capturing a richer representation of the information and nuances in the user interactions and contextual information in a fluid and scalable manner. Additionally, a sampled softmax loss may be utilized in training the recommendation model in employing the continuous representation approach.

After the first stage of training the recommendation model and/or obtaining a recommendation system employing one or more pre-trained models, which may produce a trained initial sequence model that is configured to generate sequences of content items with which it is expected that a user may engage and/or interact, a slate fine-tuning stage may be performed. For example, the trained initial sequence model may be fine-tuned over the sequence of user actions, contextual information, and slates of content items to improve the quality of the slate recommendations provided to the user. In an exemplary implementation, the sequence of user actions z, the contextual information c, and the slate s may be used to fine-tune the trained initial sequence model to determine slates of content items. In one exemplary implementation, fine-tuning of the sequence model may include training the sequence model to imitate and/or mimic a slate recommendation system employing one or more ML models.

Using this fine-tuning process, the model learns to better understand and predict the preferred slate composition of the users based on an analysis of previously generated slates, along with the corresponding previous user actions and contextual information. In exemplary implementations, the loss function and the representations used in connection with training the initial sequence model may be maintained and fine-tuned to learn the distribution of slates. Accordingly, this training stage may facilitate the trained initial sequence model to better learn and model the distribution of slates for improved recommendation quality. For example, the fine-tuned model may generate slate recommendations that are more customized to the user's tastes and preferences so as to be more engaging to users.

After fine-tuning of the trained initial sequence model and/or obtaining a slate recommendation system employing one or more pre-trained models configured to generate slate recommendations, exemplary embodiments of the present disclosure may provide a reinforcement learning technique configured to bias and/or guide the one or more models to favor certain slates in view of one or more objectives. According to certain aspects of the present disclosure, the objectives may include a particular type of response (e.g., a like, a save, a share, a click, a linking of the item, an adding of annotations, and the like), a diversity of the content items included in the slate, a content item type of the content items included in the slate, and the like. In exemplary implementations, the reinforcement learning technique may include first training a reward model, which may be initialized from the fine-tuned sequence model, such that the model architecture may be the same as the initial sequence model, except the final layer of the model may generate a scalar reward using human feedback data, and the reward model may be employed to iteratively train the recommendation model. For example, the human feedback data may be compiled as labeled training data (e.g., binary labeled format, etc.) to enforce the chosen response as having a higher reward score. In an exemplary implementation, a binary loss function may be employed, which may be represented as:

$${ℒ}_{ranking} = - log ( σ ( {r}_{θ} ( x , {y}_{c} ) - {r}_{θ} ( x , {y}_{r} ) ) )$$

where r_{θ}(x, y) may represent the scalar score output for user context x, y_{c} is the selected element, yᵣ is the rejected element, and model weights are θ. Alternatively and/or in addition, the reward model may be trained from a different pre-trained model, generated based on rule-based heuristics rather than being learned, and the like. The reward model may then be used to further fine-tune the fine-tuned sequence model using a reinforcement learning technique. In an exemplary implementation, each episode of the fine-tuning may be divided into groups of elements, where each group may be conditioned on a preceding contextual information. Accordingly, the model may be fine-tuned using a proximal policy optimization (PPO) technique, where a reward is given at the end of each group by the reward model. According to exemplary embodiments of the present disclosure, in implementing the reinforcement learning, the following objective function may be optimized:

$$objective = {𝔼}_{context ∼ D , chunk ∼ {π}_{RL}} [ \text{} {r}_{θ} ( context , group ) - β distance ( {π}_{RL} ( group \vert context ) , {π}_{SFT} ( group \vert context ) ) ]$$

where D is the dataset that contains contextual information, π_{RL} is the reinforcement learning trained policy, π_{SFT} is the fine-tuned initial sequence model trained policy, β is a weight applied to the regularization term to discourage the fine-tuned policy from diverging too much from π_{SFT}, but without preventing the policies from learning to maximize the reward. Optionally, a distance penalty (e.g. cosine distance, etc.) may be introduced from π_{SFT} at each recommended item to mitigate over-optimization of the reward model. Alternatively and/or in addition, a direct preference optimization (DPO) technique may be employed in place of the reinforcement learning technique to optimize the model using the signal generated by the reward model. For example, the reward model may be leveraged to determine a dataset of preferences and/or policies, which may be used by applying a DPO technique to optimize the model in view of the objectives used to train the reward model.

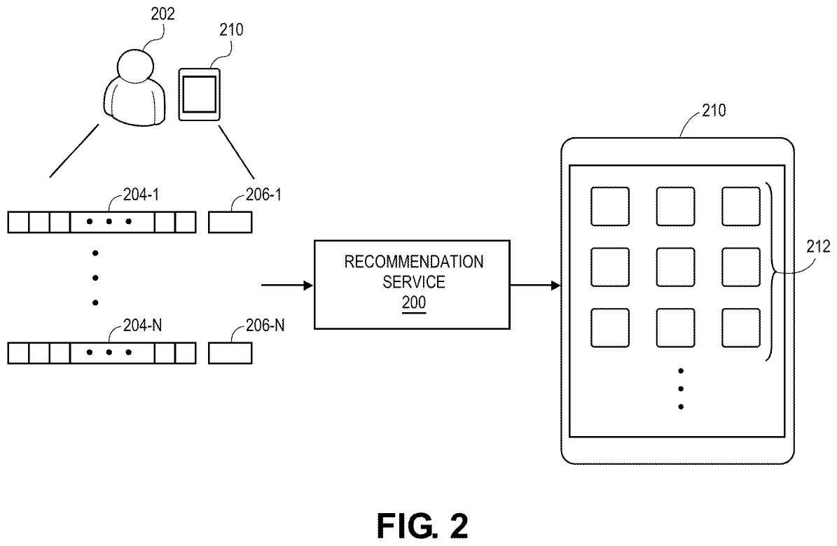

FIG. 2 is a block diagram illustrating an exemplary recommendation service 200, according to exemplary embodiments of the present disclosure. According to exemplary embodiments of the present disclosure, recommendation service 200 may include a slate recommendation model, such as slate recommendation service 125, that includes one or more trained machine learning models and is implemented by an online service, such as a social networking service, social media platform, e-commerce platform, content recommendation service, search service, and the like, that may be configured to execute on a networked computing system (e.g., computing resources 120, etc.).

As shown in FIG. 2, user 202 may access recommendation service 200 using client device 210. For example, recommendation service 200 may be implemented by an online service as part of as a social networking service, social media platform, e-commerce platform, content recommendation service, search service, and the like. In exemplary implementations, user 202 may access the online service and recommendation service 200 using client device 210 via an application executing on client device 210. In connection with user 202's activity with the online service implementing recommendation service 200, a request for a slate of content may be received by recommendation service 200 from client device 210. For example, the request for a slate of content may be included in a query (e.g., a text-based query, an image query, etc.), a request to access a homepage and/or home feed, a request for recommended content items, in connection with browsing and/or consumption of content, and the like. Alternatively and/or in addition, a slate of content may be pushed to client device 210. In response to the request for a slate of content, recommendation service 200 may determine a slate of content, which may include a presentation of multiple content items to the user. According to aspects of the present disclosure, the slate of content may include any number of content items, which may include multiple different types of content items. In an exemplary implementation, the content items may include, for example, images, advertisements, shopping objects, dynamic content items that dynamically change as users interact with them, and the like. For the example, the dynamic content items may not be simple static content items, such as images that may include a static representation, but instead may include content items that include various metadata, annotations, and/or other associated attributes, such as content graph relationships (e.g., edges, clusterings, weightings, taxonomical relationships, etc.), and the like, that may dynamically change as users interact with the content items (e.g., via likes, shares, saves, clicks, linking, the adding of annotations, etc.). Accordingly, as the metadata, annotations, content graph relationships, and/or other associated attributes associated with such content items change, the embeddings, learned ID representations, and the like encoding features of such content items will also dynamically change to reflect the changes of the content items.

According to exemplary embodiments of the present disclosure, recommendation service 200 may include one or more trained models, such as a trained generative slate recommendation model, configured to determine a slate of content based on input information associated with user 202 and the request for the slate of content. In exemplary implementations, the input information may include a sequence of user actions associated with user 202 and contextual information 206 (e.g., contextual information 206-1 through 206-N) associated with the request for the slate of content. For example, the sequence of user actions may include a sequence of content items with which user 202 has interacted. The sequence of content items may be encoded as a sequence of representations 204 (e.g., representation 204-1 through 204-N), such as embeddings, learned ID representations, and the like. Further, contextual information 206 may include contextual information associated with the request for a slate of content items (e.g., a type of request for the slate of content items-a response to a query, a request to populate a homepage, in connection with a push notification providing content, etc.—a time of the request, and the like), as well as a sequence of contextual information associated with each representation 204 of a content item in the sequence of user actions. For example, the sequence of contextual information associated with each representation 204 may include the type of interaction with the corresponding content item, a session during which the interaction occurred, the type of request (e.g., a query, a request for a home page, a request for recommended content, in connection with a push notification providing content, etc.) that initiated the interaction, and the like.

In exemplary implementations of the present disclosure, recommendation service 200 may process a sequence of user actions associated with user 202, which may include representation 204-1 through representation 204-N, and contextual information 206 (e.g., contextual information 206-1 through contextual information 206-N) to determine a sequence of content items to be included in slate 212 of content items to be presented to on client device 210 to user 202. According to certain aspects of the present disclosure, recommendation service 200 may generate a sequence of representations (e.g., embeddings, ID representations, etc.) corresponding to a sequence of content items to be included in slate 212. The content items may include multiple different types of content items. Further, in exemplary implementations where representations 204 include embeddings that are representative of content items, recommendation service 200 may be trained to generate a sequence of embeddings representative of a sequence of content items. Accordingly, the generated representations may include encodings of particular content items included in a corpus of content items (e.g., stored and maintained in content item datastore 130). Alternatively and/or in addition, the generated representations may be used to identify corresponding content items based on a similarity measure between the generated representations and the representations of content items of the corpus of content items (e.g., Euclidean similarity, cosine similarity, clustering techniques, nearest neighbor techniques, random walks, etc.) maintained in a content graph. Upon determination of the sequence of content items, slate 212 may be composed of the sequence of content items and presented to user 202 on client device 210.

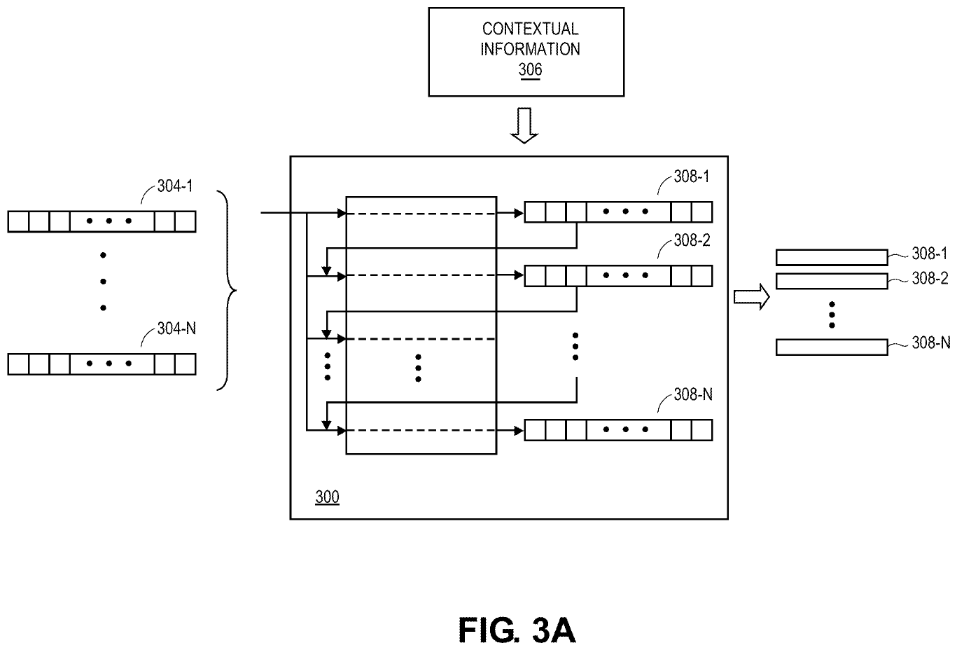

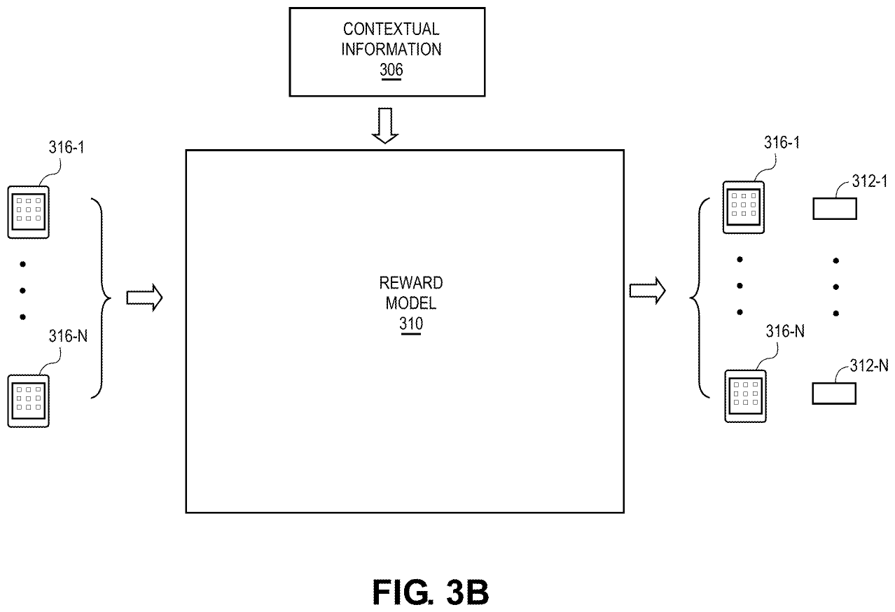

FIGS. 3A and 3B are illustrations of an exemplary sequence model 300 and an exemplary reward model 310, according to exemplary embodiments of the present disclosure. In exemplary implementations of the present disclosure, exemplary sequence model 300 and exemplary reward model 310 may represent models that may be produced at various stages during training of an exemplary slate recommendation model, in accordance with exemplary embodiments of the present disclosure.

FIG. 3A illustrates an exemplary sequence model 300, which may have been trained and/or obtained according to exemplary embodiments of the present disclosure, that may be configured to process an input of a sequence of user actions and contextual information and generate a sequence of recommended content items. In exemplary implementations, sequence model 300 may be an illustration of the initial sequence model described in connection with FIG. 1.

As shown in FIG. 3A, sequence model 300 may receive and process an input of a sequence of user actions 304 (e.g., user action 304-1 through user action 304-N) and contextual information 306 to determine a sequence of content to be included in a slate of content items. The sequence of user actions 304 may include a sequence of content items with which the user has interacted and may be encoded as a sequence of representations (e.g., embeddings, learned ID representations, and the like). Further, contextual information 306 may include contextual information associated with the request for a slate of content items and/or a sequence of contextual information (e.g., a type of request for the slate of content items—a type of request for content items—a response to a query, a request to populate a homepage, a shopping session, a request for recommended content, in connection with a push notification providing content, etc.—a time of the request, a type of interaction with the corresponding content item, a session during with the interaction occurred, the type of request that initiated the interaction, device information, device type information, device display information, device display orientation, and the like) associated with each user action in the sequence of user actions 304. In exemplary implementations, contextual information 306 may include a sequence of tokens drawn from a fixed vocabulary.

In the implementation illustrated in FIG. 3A, sequence of user actions 304 and contextual information 306 may be processed by sequence model 300 to determine one or more predicted next content item 308-1 in the sequence. After determination of content item 308-1, content item 308-1 may be added to the sequence of user actions 304, and the newly formed sequence of user actions, which includes user actions 304 and content item 308-1, may be processed, along with contextual information 306 to generate the next one or more predicted content item 308-2. Content item 308-2 may then be added to the sequence of user actions (e.g., sequence of user actions 304 plus content item 308-1 to form a sequence of user actions including user actions 304, content item 308-1, and content item 308-2), which may then be processed, along with contextual information 306, to generate the next predicted content item. The determination of the next predicted content item, adding the next predicted content item to the previous sequence of user actions and content items, and processing the new sequence to determine the next predicted content item may be iterated until the desired number of predicted content items is obtained. As shown in FIG. 3A, sequence model 300 may determine a sequence of predicted content items 308 (e.g., content items 308-1, 308-2, through 308-N) which are predicted to follow the input sequence of user actions 304. In exemplary implementations, content items 308-1 through 308-N may be used to populate a recommended slate of content.

In an exemplary implementation where sequence model 300 is generated, a first training stage of training an initial sequence model may be performed. The initial sequence model may be configured to determine a sequence of content items with which it is expected the user will interact and/or engage based on an input of a sequence of user interactions and corresponding contextual information. After the first stage of training the recommendation model, which may produce the trained initial sequence model that is configured to generate sequences of content items, a slate fine-tuning stage may be performed. Alternatively and/or in addition, a pretrained sequence recommendation system employing one or more pretrained models may be obtained and utilized in place of training an initial sequence model. For example, the trained initial sequence model and/or the pretrained initial sequence model may be fine-tuned over the sequence of user actions, contextual information, and slates of content items to improve the quality of the slate recommendations provided to the user. For example, the sequence of user actions z, the contextual information c, and the slate s may be used to fine-tune the trained initial sequence model to determine slates of content items. Using this fine-tuning process, the model learns to better understand and predict the preferred slate composition of the users based on an analysis of previous actions and context. In exemplary implementations, the loss function and the representations used in connection with training the initial sequence model may be maintained and fine-tuned to learn the distribution of slates. During this training stage, the trained initial sequence model may be fine-tuned to better learn and model the distribution of slates for improved recommendation quality. For example, the fine-tuned model may generate slate recommendations that are more customized to the user's tastes and preferences, so as to be more engaging to users. In one exemplary implementation, fine-tuning of the sequence model may include training the sequence model to imitate and/or mimic a slate recommendation model employing one or more pretrained models. Accordingly, exemplary sequence model 300 may represent the fine-tuned initial sequence model. Alternatively and/or in addition, a slate recommendation system employing one or more pre-trained models configured to generate slate recommendations may be obtained in place of fine-tuning an initial sequence model.

FIG. 3B illustrates an exemplary reward model 310, according to exemplary embodiments of the present disclosure, that may be configured to process an input of a sequence of user actions and contextual information and generate a scalar reward associated with slate recommendations. In exemplary implementations, reward model 310 may be an illustration of the reward model described in connection with FIG. 1.

As shown in FIG. 3B, reward model 310 may be configured to receive and process an input of slates 316 (e.g., slate 316-1 through slate 316-N) and contextual information 306 to determine rewards 312 (e.g., reward 312-1 through reward 312-N) associated with slates 316. According to exemplary implementations of the present disclosure, reward model 310 may be trained to generate rewards 312 for each slate 316 based on one or more objectives. Alternatively, reward model 310 may include a rule-based heuristic model rather than being learned.

In an exemplary implementation where reward model 310 is learned, reward model 310 may be initialized from sequence model 300, however, reward model 310 may be trained so that the final layer of reward model 310 generates a scalar reward (e.g., reward 312) based on one or more objectives for each slate 316. Slates 316 processed by reward model 310 may include a sequence of content items with which the user has interacted and may be encoded as a sequence of representations (e.g., embeddings, learned ID representations, and the like), and contextual information 306 may include contextual information associated with the request for a slate of content items and/or a sequence of contextual information associated with each user action in the sequence of user actions 304 (e.g., a type of request for the slate of content items—a response to a query, a request to populate a homepage, in connection with a push notification providing content, etc.—a time of the request, a type of interaction with the corresponding content item, a session during with the interaction occurred, the type of request that initiated the interaction, device information a device type, a device screen type, a device screen orientation, and the like). In exemplary implementations, contextual information 306 may include a sequence of tokens drawn from a fixed vocabulary.

In the implementation illustrated in FIG. 3B, slates 316 and contextual information 306 may be processed by reward model 310 to determine a corresponding reward 312 for each slate 316. Reward 312 may include a scalar value that may include a floating-point number (e.g., between zero and one, between negative one and positive one, etc.) representing a measure of a relevance, a quality, and/or a score of the associated slate 316 with respect to the one or more objectives. In exemplary implementations of the present disclosure, the objectives may include any desired features, considerations, preferences, and the like that may be favored in determining the composition of the slate recommendations. For example, the one or more objectives may specify a particular type of user response and/or interaction (e.g., a like, a save, a share, a click, a linking of the item, an adding of annotations, increasing a length of user sessions, and the like) for the slates, a diversity of the content items included in the slate (e.g., diversity of a date of the content items, features included in representations presented in the content items, etc.), a content item type (e.g., image, video, advertisement, dynamic content, etc.) of the content items included in the slate, and the like. Further, more than one objective may be used, so that reward 312 determined by reward model 310 optimizes reward 312 for the combination of the selected objectives. Accordingly, the slate with the highest corresponding reward may be expected to be the slate that is a relatively optimized slate in view of the selected objectives.

According to exemplary embodiments of the present disclosure, reward model 310 may be employed using a reinforcement learning technique to fine-tune sequence model 300 to bias sequence model 300 to determine slate recommendations based on the objectives used in connection with reward model 310. Thus, fine-tuning sequence model 300 using reward model 310 can facilitate encoding sequence model 300 with the objectives used in training reward model 310, thereby configuring sequence model 300 to have a bias for and/or be guided to recommending slates that maximize the rewards determined by reward model 310. In an exemplary implementation of the present disclosure, fine-tuning sequence model 300 may be performed offline using simulated training data. In exemplary implementations, each episode of the fine-tuning may include a group of elements conditioned on preceding contextual information, and sequence model 300 may be fine-tuned using a proximal policy optimization (PPO) technique, where a reward is given at the end of each episode by reward model 310. Further, in implementations where it may be desirable to update, change, and/or modify the objectives, as different objectives are selected, a new reward model 310 may be trained using the newly selected objectives (or reward model 310 may be retrained using the new selected objectives), and the new reward model 310 may be employed using a reinforcement learning technique to fine-tune sequence model 300 to bias sequence model 300 to determine slate recommendations based on the newly selected objectives used in training reward model 310. Alternatively and/or in addition, a direct preference optimization (DPO) technique may be employed in place of the reinforcement learning technique to optimize sequence model 300 using rewards 312. For example, reward model 310 may be leveraged to determine a dataset of preferences and/or policies, which may be used by applying a DPO technique to optimize sequence model 300 in view of the objectives used to train the reward model.

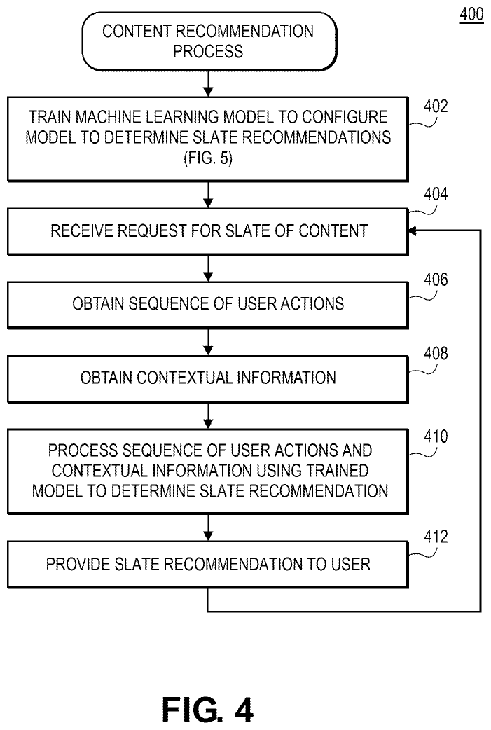

FIG. 4 is a flow diagram of an exemplary content recommendation process 400, according to exemplary embodiments of the present disclosure. In exemplary implementations, exemplary content recommendation process 400 may be performed, for example, by slate recommendation service 125 and/or recommendation service 200.

As shown in FIG. 4, exemplary content recommendation process 400 may begin with the training of a machine learning model to configure the model to determine slate recommendations, as in step 402. According to exemplary embodiments of the present disclosure, a generative end-to-end model may be trained to determine a recommended slate of content items, which may include a sequence of content items, to present to a user. For example, a generative model may be trained to learn a sequence model configured to generate a sequence of content items based on a user's history, contextual information, and the like. The trained model may then be fine-tuned to better learn a distribution of recommended slates of content items for improved quality in the recommended slates that are presented to the user. After fine-tuning of the model, a reward model may be trained based on one or more objectives. The reward model may be employed using a reinforcement learning technique to further fine-tune the model to bias the slate recommendations in view of the one or more objectives. The trained model may then be deployed as part of a recommendation system to serve slate recommendations to users that are based at least in part on the one or more objectives. Training of the machine learning model is described in further detail herein in connection with at least FIGS. 1 and 5-7.

In step 404, a request for a slate of content may be received. In exemplary implementations of the present disclosure, the request for the slate of content may be included in a query (e.g., a text-based query, an image query, etc.), a request to access a homepage and/or home feed, a request for recommended content items, in connection with the browsing and/or consuming of content via the service, and the like.

In view of the request for the slate of content, a sequence of user actions may be obtained, as in step 406, and contextual information may be obtained, as in step 408, in connection with the request for the slate of content, which may be processed by the trained machine learning model to determine a recommended slate of content in response to the request for the slate of content. According to exemplary embodiments of the present disclosure, the sequence of user actions may correspond to a sequence of content items with which the user has interacted, and the contextual information may include information associated with the request for content items (e.g., a type of request for content items—a response to a query, a request to populate a homepage, in connection with a push notification providing content, etc.—a time of the request for content, device information, a device type, a device screen type, a device screen orientation, and the like). Further, according to certain aspects of the present disclosure, the content items may include multiple different types of content items and the content items may not be simple static content items, such as images that may include a static representation. Rather, the content items may include content items that include various metadata, annotations, and/or other associated attributes, such as content graph relationships (e.g., edges, clusters, weightings, taxonomical relationships, etc.), and the like, that dynamically change as users interact with them. According to certain aspects of the present disclosure, the content items may be encoded as embeddings, learned ID representations, and the like.

In step 410, the sequence of user actions and the contextual information may be processed by the trained model to determine a slate recommendation in response to the request for a slate of content. According to exemplary embodiments of the present disclosure, the trained model may be configured to determine a sequence of content items to populate a slate of content as the slate recommendation. According to certain aspects of the present disclosure, the sequence of content items may include content items of multiple different types. Further, the trained model may be configured so as to bias the model to determine the slate recommendation based on one or more selected objectives. For example, the one or more objectives may specify a particular type of user response and/or interaction (e.g., a like, a save, a share, a click, a linking of the item, an adding of annotations, increasing a length of user sessions, and the like) for the slates, a diversity of the content items included in the slate (e.g., diversity of a date of the content items, features included in representations presented in the content items, etc.), a content item type (e.g., image, video, advertisement, dynamic content, etc.) of the content items included in the slate, and the like. In determining the slate recommendations, the contextual information, such as the type of request for content, the time of the request, and device information and characteristics may influence the type, number, arrangement, etc. of content items in the slate. For example, a laptop computer and a desktop computer may include a slate that includes a greater number of content items, a larger version of the content items, and the like, relative to slates that are determined for mobile devices. And in step 412, the slate recommendation may be provided to the user in response to the request for a slate of content.

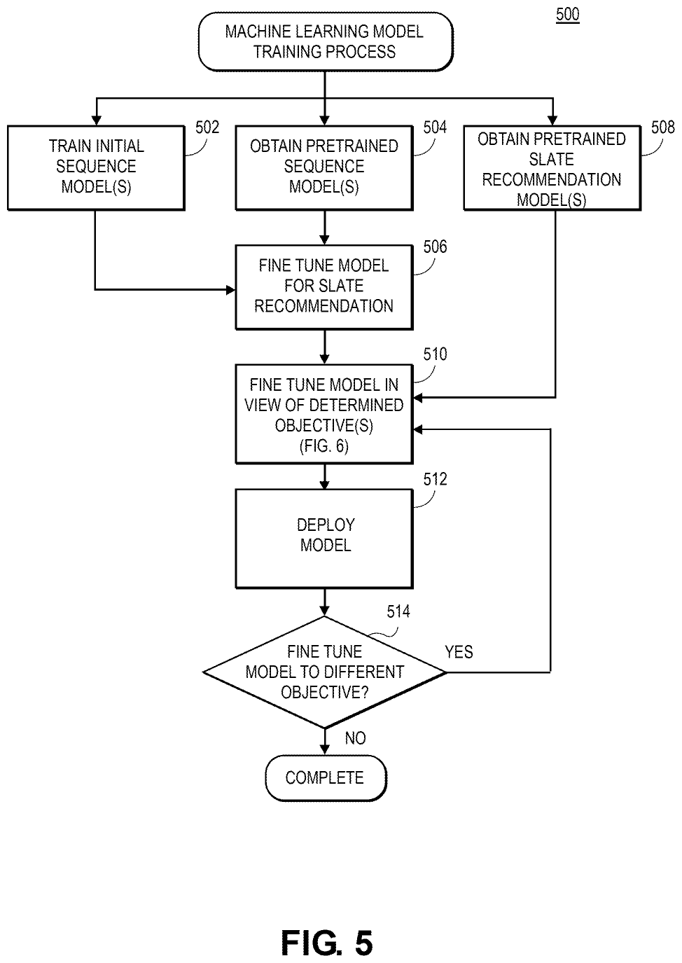

FIG. 5 is a flow diagram illustrating an exemplary machine learning model training process 500, according to exemplary embodiments of the present disclosure. For example, exemplary machine learning model training process 500 may be used to train an end-to-end generative slate recommendation model, in accordance with exemplary embodiments of the present disclosure.

As shown in FIG. 5, in step 502, an initial sequence model may be trained and fine-tuned for slate generation. In training the initial sequence model, the recommendation model may first be trained to generate a sequence model configured to learn a conditional probability indicative of the probability of each subsequent user interaction, given the preceding user actions in a sequence. The trained sequence model may then be fine-tuned using training data incorporating user history, contextual information, and content item slate information, so that the model may further learn relationships and patterns between the sequence of content items in the recommended slates of content items.

In exemplary implementations of the present disclosure, slate recommendations may be framed as a sequence generation problem. Accordingly, the corpus of content items may be represented as D, and a slate s of size K may be defined as an ordered list of items where s=(d₁, d₂, . . . , d_{K}), where dₖ∈D and positional index k∈{1, . . . , K} represents that the item appeared in the k-th slot in the slate. A user's response to a slate s is denoted as r=(r₁, r₂, . . . , r_{K}), where rₖ may represent the user's response to item dk, where rₖ∈{0, 1} and represents whether the user engaged with item dₖ. Additionally, z may represent a user's history (e.g., that may be represented as a sequence of user interactions) and c may represent contextual information (e.g., the type of the request for a slate—a query, request to access a homepage, etc.—a timestamp, and the like). Unlike traditional discriminative ranking methods that model R (r|s, z, c), which represents the user response for a given slate, the exemplary generative recommendation model, according to exemplary embodiments of the present disclosure, is configured to learn the distribution of slates, which may be represented as P_θ(s|z, c).

Further, the user history z may be expressed as z=i_1, i_2, . . . , i_n, and the context may be represented as a string of tokens drawn from a fixed vocabulary. According to an aspect of the present disclosure, in implementations where the request for a slate of content items is received in connection with a search and/or query, the contextual information may include the search query as a tokenized query. Accordingly, the slate recommendation problem may be represented as learning the probability of:

$$P ( s \vert i\_ 1 , i\_ 2 , … , i\_n , c\_ 1 , c\_ 2 , … , c\_m )$$

Additionally, certain aspects of the present disclosure may also apply a causal relationship between content items included in the slate. For example, it may be assumed that users typically engage a slate of content items from the beginning of the slate to the end of the slate. Accordingly, it may be assumed that content items may be influenced by preceding content items in the slate, but not by content items subsequently appearing in the slate. Alternatively and/or in addition, the content items may be considered as groupings of content items rather than individual content items in the slate. Based on the above assumptions, the slate recommendation problem may be explained as learning the likelihood of an item at slot i of the slate s based on user history z, context c, and prior slate items s_x<i, which may be represented as learning the probability of:

$$P ( s\_i \vert i\_ 1 , i\_ 2 , … , i\_n , c\_ 1 , c\_ 2 , … , c\_m , s\_ 1 , s\_ 2 , … , s\_i - 1 )$$

Further, exemplary embodiments of the present disclosure may employ a reinforcement learning technique with a reward model to maximize a cumulative reward for the slate based on one or more objectives. According to an exemplary implementation, the fine-tuning of the model based on the objective may be represented as:

$$objective = arg {max}_{π} {𝔼}_{context ∼ D , s \_ i \sim P ( s \_ i \vert i \_ 1 , … )} [ {r}_{θ} ( context , s\_i ) ) ]$$

According to exemplary embodiments of the present disclosure, a supervised learning technique may be employed to train the initial sequence model using training data incorporating user interaction information and contextual information. For example, user history and contextual information may be collated as sequences in the generation of training data. Accordingly, given a sequence of user interactions and a sequence of contextual information, a model (e.g., a decoder-only transformer model, etc.) may be trained to learn a conditional probability indicative of the probability of each subsequent user interaction given the preceding user actions in the sequence.

Further, exemplary embodiments of the present disclosure may employ either a discrete or a continuous representation approach in training the generative recommendation model. In a discrete representation approach, the sequence of user interactions and the contextual information may be represented utilizing hierarchical semantic identifiers, while the contextual information is represented by a set of tokens. The discrete representation approach can facilitate encapsulating the information concisely and in a structured manner, which can facilitate improved interpretability of patterns in the information. Further, a cross-entropy loss may be employed in training the recommendation model in employing the discrete representation approach.

In a continuous representation approach, pretrained embeddings may represent both the sequence of user interactions and the contextual information. The continuous representation approach can facilitate capturing a richer representation of the information and nuances in the user interactions and contextual information in a fluid and scalable manner. Additionally, a sampled softmax loss may be utilized in training the recommendation model in employing the continuous representation approach.

Alternatively, as shown in step 504 of FIG. 5, a pretrained sequence recommendation system employing one or more pretrained models may be obtained and utilized rather than performing the training the initial sequence model in step 502. After training and/or obtaining of the initial sequence model, which may produce a trained initial sequence model that is configured to generate sequences of content items based on predicted user interactions with the sequence of content items, a slate fine-tuning stage may be performed, as in step 506. For example, the initial sequence model may be fine-tuned over the sequence of user actions, contextual information, and slates of content items to improve the quality of the slate recommendations provided to the user. In an exemplary implementation, the sequence of user actions z, the contextual information c, and the slate s may be used to fine-tune the trained initial sequence model to determine slates of content items. In one exemplary implementation, fine-tuning of the sequence model may include training the sequence model to imitate and/or mimic a slate recommendation system employing one or more pretrained model(s). Using this fine-tuning process, the model learns to better understand and predict the preferred slate composition of the users based on an analysis of previously generated slates, along with the corresponding previous user actions and contextual information. In exemplary implementations, the loss function and the representations used in connection with training the initial sequence model may be maintained and fine-tuned to learn the distribution of slates. Accordingly, this training stage may facilitate the trained initial sequential model to better learn and model the distribution of slates for improved recommendation quality. For example, the fine-tuned model may generate slate recommendations that are more customized to the user's tastes and preferences, so as to be more engaging to users. Alternatively, as shown in step 508 of FIG. 5, a slate recommendation system employing one or more pretrained models may be obtained and utilized rather than performing the fine-tuning of the model in step 506.

After fine-tuning of the trained initial sequence model or obtaining a pretrained slate recommendation model, exemplary embodiments of the present disclosure may provide a reinforcement learning technique configured to bias and/or guide the model to favor certain slates in view of one or more objectives. Accordingly, as shown in FIG. 5, one or more objectives may be determined, and the model may be fine-tuned in view of the determined objective(s), as in step 510. For example, the one or more objectives may specify a particular type of user response and/or interaction (e.g., a like, a save, a share, a click, a linking of the item, an adding of annotations, increasing a length of user sessions, and the like) for the slates, a diversity of the content items included in the slate (e.g., diversity of a date of the content items, features included in representations presented in the content items, etc.), a content item type (e.g., image, video, advertisement, dynamic content, etc.) of the content items included in the slate, and the like.

After the one or more objectives have been determined, the model may be fine-tuned in view of the determined objectives. According to exemplary implementations, a reward model may be trained to generate a reward signal based on one or more objectives, and the reward signal from the trained reward model may be employed using a reinforcement learning human feedback (RLHF) technique to fine-tune the model to maximize the reward, thereby biasing the model to slate recommendations based on the one or more objectives. Alternatively and/or in addition, a direct preference optimization (DPO) technique may be employed in place of the reinforcement learning technique to optimize the model in view of the determined objective(s). Fine-tuning the model in view of the selected objectives is described in further detail herein in connection with at least FIGS. 1, 6, and 7. After fine-tuning of the model, the model may be deployed, as in step 512.

Further, as exemplary embodiments of the present disclosure can facilitate fine-tuning the model in view of newly selected objectives without having to retrain the entire model, in step 514, it may be determined whether the model is to be retrained in view of newly selected objectives. Accordingly, in situations where the model is to be retrained based on newly selected objectives, exemplary process 500 may return to step 510, where one or more objectives may be determined and used to again fine-tune the model in view of the determined objective(s). Alternatively, exemplary process 500 may complete.

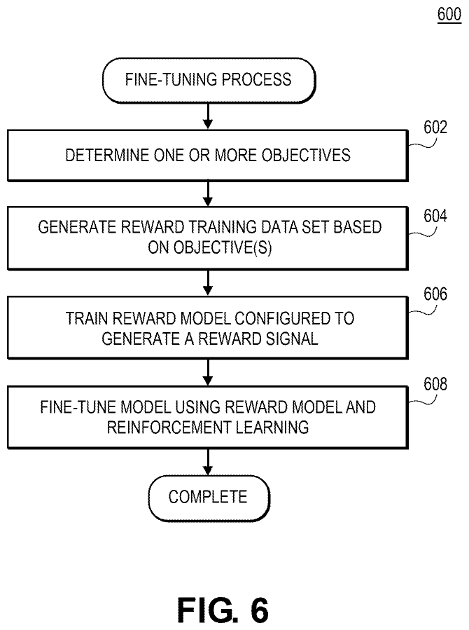

FIG. 6 is a flow diagram of an exemplary fine-tuning process 600, according to exemplary embodiments of the present disclosure.

As shown in FIG. 6, in step 602, one or more objectives may be determined. The one or more objectives may include any metric, feature, etc. that is desired to be maximized in connection with the slate recommendations determined by the trained model. For example, the one or more objectives may specify a particular type of user response and/or interaction (e.g., a like, a save, a share, a click, a linking of the item, an adding of annotations, increasing a length of user sessions, and the like) for the slates, a diversity of the content items included in the slate (e.g., diversity of a date of the content items, features included in representations presented in the content items, etc.), a content item type (e.g., image, video, advertisement, dynamic content, etc.) of the content items included in the slate, and the like. Additionally, more than one objective may be selected, so that the trained model is fine-tuned to be optimized for the combination of the selected objectives.

Using the one or more objectives, a reward training dataset may be generated, as in step 604. According to exemplary embodiments of the present disclosure, the reward training dataset may be generated using human feedback data. For example, the human feedback data may be compiled as labeled training data (e.g., binary labeled format, etc.) based on user responses and/or interactions in connection with slates of content presented to the user in view of the determined one or more objectives. In an exemplary implementation, the human feedback data may be divided into groups of elements that are ranked based on the type of human response to the data.

Using the generated training dataset, in step 606, a reward model may be trained to generate a reward signal. Accordingly, the reward model may be trained to determine a reward in connection with determined slates of content. Alternatively and/or in addition, the reward model may be generated based on rule-based heuristics rather than being learned. For example, the reward may include a scalar value that may include a floating-point number (e.g., between zero and one, between negative one and positive one, etc.) representing a measure of a relevance, a quality, and/or a score of the slate recommendation in view of the one or more objectives. The reward model may be initialized from initial sequence model (e.g., trained in step 502 of FIG. 5), such that the model architecture may be the same as the initial sequence model, except the final layer of the model may generate a scalar reward. In an exemplary implementation where the human feedback data is compiled into a binary ranking labeled format (e.g., better vs. worse), the chosen response can be enforced to have a higher score than its counterpart, and the loss function used may be represented as:

$${ℒ}_{ranking} = - log ( σ ( {r}_{θ} ( x , {y}_{c} ) - {r}_{θ} ( x , {y}_{r} ) ) )$$

where r_{θ}(x, y) may represent the scalar score output for user context x, y_{c} is the selected element, yᵣ is the rejected element, and model weights are θ.

The reward model may then be used to iteratively fine-tune the model, using a reinforcement learning technique, as in step 608. In an exemplary implementation, each episode of the fine-tuning may include a group of elements conditioned on a preceding contextual information, and the model may be fine-tuned using a proximal policy optimization (PPO) technique, where a reward is given at the end of each episode by the reward model. According to exemplary embodiments of the present disclosure, in implementing the reinforcement learning, the following objective function may be optimized:

$$objective = {𝔼}_{context ∼ D , chunk ∼ {π}_{RL}} [ \text{} {r}_{θ} ( context , group ) - β distance ( {π}_{RL} ( group \vert context ) , {π}_{SFT} ( group \vert context ) ) ]$$

where D is the dataset that contains contextual information, π_{RL} is the reinforcement learning trained policy, π_{SFT} is the fine-tuned initial sequence model trained policy, β is a weight applied to the regularization term to discourage the fine-tuned policy from diverging too much from π_{SFT}, but without preventing the policies from learning to maximize the reward. Optionally, a distance penalty (e.g. cosine distance, etc.) may be introduced from π_{SFT} at each recommended item to mitigate over-optimization of the reward model. Alternatively and/or in addition, an optimization (e.g., DPO, etc.) technique may be employed in place of the reinforcement learning technique to optimize the model using the signal generated by the reward model. For example, the reward model may be leveraged to determine a dataset of preferences and/or policies, which may be used applying a DPO technique to optimize the model in view of the objectives used to train the reward model. Exemplary process 600 may then complete.

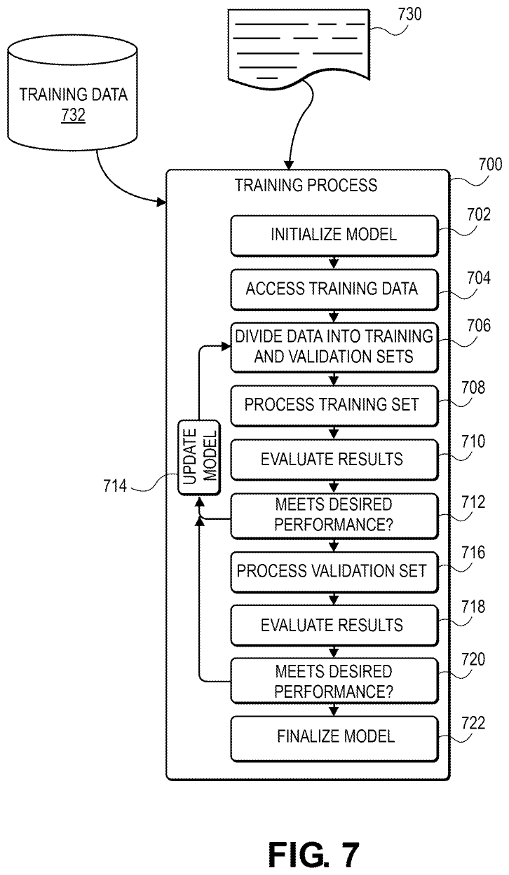

FIG. 7 is a flow diagram of an exemplary machine learning model training process 700, according to exemplary embodiments of the present disclosure. In exemplary implementations, exemplary machine learning model training process 700 may be employed during one or more stages of training an end-to-end generative slate recommendation system, as described herein.

As shown in FIG. 7, exemplary machine learning model training process 700 may begin, at step 702, by initializing the model with training criteria 730. Training criteria 730 may include, but is not limited to, information as to a type of training, and number of layers to be trained, etc.

At step 704 of training process 700, corpus of training data 732 may be accessed. For example, training data 732 may include labeled training data corresponding to content items, contextual information, slate recommendations and the like that may be used in connection with training an initial sequence model and/or fine-tuning the initial sequence model, human feedback data in connection with training of a reward model, and the like, in accordance with exemplary embodiments of the present disclosure.

With training data 732 accessed, at step 706, training data 732 may be divided into training and validation sets. Generally speaking, the items of data in the training set are used to train the untrained model and the items of data in the validation set are used to validate the training of the model. As those skilled in the art will appreciate, and as described below in regard to much of the remainder of training process 700, there are numerous iterations of training and validation that occur during the training of the model.

At step 708 of training process 700, the data items of the training set are processed, often in an iterative manner. Processing the data items of the training set may include capturing the processed results. After processing the data items of the training set, at step 710, the aggregated results of processing the training set are evaluated, and at step 712, a determination is made as to whether a desired performance level has been achieved. If the desired performance level is not achieved, in step 714, aspects of the model are updated in an effort to guide the machine learning model to improve its performance, and processing returns to step 706, where a new set of training data is selected, and the process repeats. Alternatively, if the desired performance is achieved, training process 700 advances to step 716.

At step 716, and much like step 708, the data items of the validation set are processed, and at step 718, the processing performance of this validation set is aggregated and evaluated. At step 720, a determination is made as to whether a desired performance level, in processing the validation set, has been achieved. If the desired performance level is not achieved, in step 714, aspects of the machine learning model are updated in an effort to guide the machine learning model to improve its performance, and processing returns to step 706. Alternatively, if the desired accuracy level is achieved, the training process 700 advances to step 722. At step 722, a finalized, trained model is generated. Typically, though not exclusively, as part of finalizing the now-trained model, portions of the model that are included in the model during training for training purposes are extracted, thereby generating a more efficient trained model.

FIG. 8 is a block diagram of an exemplary computing resource 800, according to exemplary embodiments of the present disclosure. According to certain implementations, computing resource 800 may form, for example, at least a portion of computing resources 120, and may include and/or execute slate recommendation service 125. In exemplary implementations, multiple computing resources 800 may be included in the system.

As shown in FIG. 8, computing resource 800 may include one or more controllers and/or processors 804, that may each include a central processing unit (CPU) for processing data and computer-readable instructions, and memory 806 for storing data and instructions. Memory 806 may individually include volatile random-access memory (RAM), non-volatile read only memory (ROM), non-volatile magnetoresistive random-access memory (MRAM) and/or other types of memory. Each computing resource 800 may also include a data storage component 808, which can include several separate data tables, databases or other data storage mechanisms and media for storing data relating to, for example, content items, user interactions and/or activity, contextual information, corresponding metadata, and the like. Each data storage component may individually include one or more non-volatile storage types, such as magnetic storage, optical storage, solid-state storage, etc. Each computing resource 800 may also be connected to removable or external non-volatile memory and/or storage (such as a removable memory card, memory key drive, networked storage, etc.), internal, and/or external networks 850 (e.g., the Internet, cellular networks, satellite networks) through respective input/output device interfaces 832.

Computer instructions for operating computing resource 800 and its various components may be executed by the respective server's controller(s)/processor(s) 804, using memory 806 as temporary “working” storage at runtime. The computer instructions may be stored in a non-transitory manner in non-volatile memory 806, data storage 808, and/or an external device(s). Alternatively, some or all of the executable instructions may be embedded in hardware or firmware on the respective device in addition to or instead of software.

As shown in FIG. 8, computing resource 800 may also include one or more trained machine learning model 870, as discussed herein. In some implementations, trained machine learning model 870 may include an end-to-end generative slate recommendation model and may be configured to determine slate recommendations of content, according to the implementations described herein. For example, memory 806 may store program instructions that, when executed by the controller(s)/processor(s) 804, cause the controller(s)/processors 804 to, in conjunction with machine learning model 870, determine slate recommendations, as discussed herein. In other implementations, trained machine learning model 870 may exist on both computing resource 800 and/or each client device.

Computing resource 800 may also include input/output device interfaces 832. A variety of components may be connected through the input/output device interfaces. Additionally, computing resource 800 may also include an address/data bus 824 for conveying data among components of the respective server. Each component within computing resource 800 may also be directly connected to other components in addition to (or instead of) being connected to other components across bus 824.

The components of data bus 824, as illustrated in FIG. 8, are exemplary, and may be located as a stand-alone device or may be included, in whole or in part, as a component of a larger device or system.

Aspects of the disclosed system may be implemented as a computer method or as an article of manufacture, such as a memory device or non-transitory computer readable storage medium. The computer readable storage medium may be readable by a computer and may comprise instructions for causing a computer or other device to perform processes described in the present disclosure. The computer readable storage media may be implemented by a volatile computer memory, non-volatile computer memory, hard drive, solid-state memory, flash drive, removable disk, and/or other media. In addition, components of one or more of the modules and engines may be implemented in firmware or hardware.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the field of computers, communications, media files, and machine learning should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some, or all of the specific details and steps disclosed herein.

It should be understood that, unless otherwise explicitly or implicitly indicated herein, any of the features, characteristics, alternatives or modifications described regarding a particular implementation herein may also be applied, used, or incorporated with any other implementation described herein, and that the drawings and detailed description of the present disclosure are intended to cover all modifications, equivalents and alternatives to the various implementations as defined by the appended claims. Moreover, with respect to the one or more methods or processes of the present disclosure shown or described herein, including but not limited to the flow charts shown in FIGS. 4-7, orders in which such methods or processes are presented are not intended to be construed as any limitation on the claims, and any number of the method or process steps or boxes described herein can be combined in any order and/or in parallel to implement the methods or processes described herein. In addition, some process steps or boxes may be optional. Also, the drawings herein are not drawn to scale.

Moreover, the systems and methods described herein may be implemented in electronic hardware, computer software, firmware, or any combination thereof. For example, in some implementations, processes or methods described herein may be operated, performed or executed using computer-readable media having sets of code or instructions stored thereon. Such media may include, but need not be limited to, random-access memory (“RAM”) such as synchronous dynamic random-access memory (“SDRAM”), read-only memory (“ROM”), non-volatile random-access memory (“NVRAM”), electrically erasable programmable read-only memory (“EEPROM”), FLASH memory, magnetic or optical data storage media, or others. Alternatively, or additionally, the disclosed implementations may be realized at least in part by a computer-readable communication medium that carries or communicates program code in the form of instructions or data structures and that may be accessed, read, and/or executed by a computer. Additionally, code or instructions may be executed by one or more processors or other circuitry. For example, in some implementations, such components may include electronic circuits or hardware, programmable electronic circuits such as microprocessors, graphics processing units (“GPU”), digital signal processors (“DSP”), central processing units (“CPU”) or other suitable electronic circuits, which may be executed or implemented using computer software, firmware, or any combination thereof, to perform the various operations described herein.

Although the disclosure has been described herein using exemplary techniques, components, and/or processes for implementing the present disclosure, it should be understood by those skilled in the art that other techniques, components, and/or processes or other combinations and sequences of the techniques, components, and/or processes described herein may be used or performed that achieve the same function(s) and/or result(s) described herein and which are included within the scope of the present disclosure.

Disjunctive language such as the phrase “at least one of X, Y, or Z,” or “at least one of X, Y and Z,” unless specifically stated otherwise, is otherwise understood with the context as used in general to present that an item, term, etc., may be any of X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Unless otherwise explicitly stated, articles such as “a” or “an” should generally be interpreted to include one or more described items. Accordingly, phrases such as “a device configured to” or “a device operable to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Conditional language, such as, among others, “can,” “could,” “might,” or “may,” unless specifically stated otherwise, or otherwise understood within the context as used, is generally intended to convey in a permissive manner that certain implementations could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

Although the invention has been described and illustrated with respect to illustrative implementations thereof, the foregoing and various other additions and omissions may be made therein and thereto without departing from the spirit and scope of the present disclosure.

What is claimed is:

1. A computer-implemented method, comprising:
training an end-to-end generative slate recommendation model, wherein training the end-to-end generative slate recommendation model includes:
accessing a training dataset including a plurality of user history training data and a plurality of contextual training data;
training, using the training dataset, a sequence model configured to determine a sequence of recommended content items based on an input user history and an input contextual information;
fine-tuning the sequence model using the training dataset and a plurality of slate information, to generate a fine-tuned sequence model configured to determine recommended content items further based at least in part on relationships between the sequence of recommended content items for populating a slate recommendation for a user;
training, using the fine-tuned sequence model and a plurality of feedback information, at least one reward model based at least in part on an objective; and
fine-tuning the fine-tuned sequence model using the at least one reward model and at least one of a reinforcement learning technique or a direct preference optimization technique to generate the end-to-end generative slate recommendation model.

2. The computer-implemented method of claim 1, wherein:
the at least one reward model is configured to determine a reward associated with the slate recommendation; and
the reward includes a scalar value representing a quality of the slate recommendation based at least in part on the objective.

3. The computer-implemented method of claim 1, wherein fine-tuning the fine-tuned sequence model biases the end-to-end generative slate recommendation model to determine slate recommendations based at least in part on the objective.

4. The computer-implemented method of claim 1, further comprising, without retraining an entirety of the end-to-end generative slate recommendation model:
determining a new objective;
training at least one second reward model using the fine-tuned sequence model and the plurality of feed back information based at least in part on the new objective; and
fine-tuning, using the at least one second reward model, at least one of the fine-tuned sequence model or the end-to-end generative slate recommendation model to generate a second end-to-end generative slate recommendation model.

5. The computer-implemented method of claim 1, wherein fine-tuning of the sequence model includes training the sequence model to imitate a recommendation system employing one or more machine learning models.

6. A computer-implemented method, comprising:
receiving a request for a slate of content for a user;
processing, using a trained generative slate recommendation model, a sequence of user interactions associated with the user and a plurality of contextual information to determine a slate recommendation for the user, wherein:
the slate recommendation includes a recommended sequence of content items; and
the trained generative slate recommendation model was trained based at least in part on an initial sequence model and a reward model; and
causing the slate recommendation to be presented on a client device associated with the user.

7. The computer-implemented method of claim 6, wherein the sequence of user interactions includes a sequence of content items with which the user interacted.

8. The computer-implemented method of claim 7, wherein at least one of the sequence of content items or the recommended sequence of content items includes content items of more than one content item type.

9. The computer-implemented method of claim 7, wherein the sequence of content items are represented as a sequence of embeddings encoding features of content items included in the sequence of content items.

10. The computer-implemented method of claim 7, wherein the sequence of content items includes a first dynamic content item encoded as a respective embedding that is configured to dynamically change based on user interactions with the first dynamic content item.

11. The computer-implemented method of claim 6, wherein the plurality of contextual information includes at least one of:
a type of request for the slate of content;
a time of the request for the slate of content;
a device type;
a device display type; or
a device display orientation.

12. The computer-implemented method of claim 11, wherein the type of request for the slate of content includes at least one of:
a query;
a request to access a homepage;
a shopping session; or
a request for recommended content.

13. The computer-implemented method of claim 6, wherein determination of content items in the recommended sequence of content items is based at least in part on preceding content items in the recommended sequence of content items.

14. The computer-implemented method of claim 6, wherein determination of content items in the recommended sequence of content items is not based on subsequent content items in the recommended sequence of content items.

15. The computer-implemented method of claim 6, wherein training a reward model is based at least in part on a plurality of objectives.

16. A computing system, comprising:
one or more processors; and
a memory storing program instructions that, when executed by the one or more processors, cause the one or more processor to at least:
obtain a slate recommendation model configured to determine slates of recommended content items;
determine at least one objective for a reward model;
generate a reward model to determine a reward for slates of recommended content items determined by the slate recommendation model based at least in part on the at least one objective;
optimize, based at least in part on the reward model, the slate recommendation model to generate an optimized slate recommendation model configured to determine slate recommendations based at least in part on the at least one objective;
receive a request for a slate of content for a user;
process, using the optimized slate recommendation model, a sequence of user interactions associated with the user and a plurality of contextual information associated with the request to determine a user slate recommendation; and
return the user slate recommendation.

17. The computing system of claim 16, wherein optimizing the slate recommendation model includes employing at least one of a reinforcement learning technique or a direct preference optimization technique.

18. The computing system of claim 16, wherein the program instruction that, when executed by the one or more processors, further causes the one or more processors to at least:
without retraining an entirety of the slate recommendation model:
determine a new objective;
train, based at least in part on the new objective, a second reward model to determine a reward for slates of recommended content items determined by the fine-tuned sequence model based at least in part on the new objective; and
fine-tune, using the second reward model and at least one of the reinforcement learning technique or the direct preference optimization technique, the fine-tuned sequence model to generate a second slate recommendation model configured to determine second slate recommendations based at least in part on the new objective.

19. The computing system of claim 16, wherein:
the plurality of contextual information includes a type of request for the slate of content; and
the type of request for the slate of content includes at least one of:
a query;
a request to access a homepage;
a shopping session;
a request to push content; or
a request for recommended content.

20. The computing system of claim 16, wherein the user slate recommendations includes a plurality of representations encoding a sequence of content items forming the user slate recommendation.
